(19) United States
(12) Patent Application Publication
(10) Pub. No.: US 2022/0166298 A1
(43) Pub. Date: May 26, 2022

(54) ROTARY MOTOR AND ROBOT

(71) Applicant: Seiko Epson Corporation, Tokyo (JP)

(72) Inventor: Makoto MURAKAMI, Shiojiri (JP)

(21) Appl. No.: 17/534,570

(22) Filed: Nov. 24, 2021

(30) Foreign Application Priority Data
Nov. 26, 2020 (JP) 2020-195826

(51) Int. Cl. H02K 21/24; B25J 9/12; H02K 1/2793; H02K 3/28

(52) U.S. Cl. CPC H02K 21/24; H02K 3/28; H02K 1/2793; B25J 9/126

(57) ABSTRACT

A rotary motor includes a first stator including a plurality of first cores and a first coil, a signal of any one of a first phase, a second phase, and a third phase forming a three-phase alternating current flowing to the first coil, a second stator including a plurality of second cores and a second coil, a signal of any one of the first phase, the second phase, and the third phase forming the three-phase alternating current flowing to the second coil, and a rotor disposed between the first stator and the second stator via a gap and including a plurality of magnets arranged side by side in a circumferential direction around a rotation axis. A center of gravity of the first core around which the first coil to which the signal flows is wound and a center of gravity of the second core around which the second coil to which a signal of the same phase as the phase of the signal flowing to the first coil flows is wound are shifted from each other in the circumferential direction.

The present application is based on, and claims priority from JP Application Serial Number 2020-195826, filed Nov. 26, 2020, the disclosure of which is hereby incorporated by reference herein in its entirety.

### BACKGROUND

### 1. Technical Field

The present disclosure relates to a rotary motor and a robot.

### 2. Related Art

JP-A-2009-33885 (Patent Literature 1) discloses an axial gap motor including a rotor fixed to a rotating shaft and a first stator and a second stator disposed on axial direction both sides of the rotor. The rotor includes a circular rotor yoke, through the center of which the rotating shaft inserted and fixed, and a magnet fixed to the rotor yoke. The first stator and the second stator respectively include stator plates and U-phase stators, V-phase stators, and W-phase stators fixed to the stator plates.

The U-phase stators, the V-phase stators, and the W-phase stators respectively include teeth and poles and coils wound around the teeth. When an electric current is supplied to the coils, rotating magnetic fields are generated in the poles. The rotor rotates in response to the generation of the rotating magnetic fields. A signal of a U phase of a three-phase alternating current is supplied to the coil of the U-phase stator. A signal of a V phase of the three-phase alternating current is supplied to the coil of the V-phase stator. A signal of a W phase of the three-phase alternating current is supplied to the coil of the W-phase stator.

In Patent Literature 1, the pole of the U phase included in the first stator and the pole of the U phase included in the second stator are provided to overlap each other in the axial direction. Similarly, the pole of the V phase included in the first stator and the pole of the V phase included in the second stator and the pole of the W phase included in the first stator and the pole of the W phase included in the second stator are also respectively provided to overlap each other in the axial direction. “Overlap each other in the axial direction” is used in meaning that positions in the circumferential direction are the same.

In the axial gap motor disclosed in Patent Literature 1, since the poles of the phases overlap each other in the axial direction, large torque fluctuation is caused and controllability of an axial gap motor 9 is deteriorated. Such deterioration in the controllability causes worsening of convenience of use such as deterioration in position accuracy of the axial gap motor 9 and occurrence of vibration during an operation.

### SUMMARY

A rotary motor according to an application example of the present disclosure includes: a first stator including a plurality of first cores and a first coil wound around each of the first cores, a signal of any one of a first phase, a second phase, and a third phase forming a three-phase alternating current flowing to the first coil; a second stator including a plurality of second cores and a second coil wound around each of the second cores, a signal of any one of the first phase, the second phase, and the third phase forming the three-phase alternating current flowing to the second coil; and a rotor disposed between the first stator and the second stator via a gap and including a plurality of magnets arranged side by side in a circumferential direction around a rotation axis. A center of gravity of the first core around which the first coil to which the signal flows is wound and a center of gravity of the second core around which the second coil to which a signal of a same phase as the phase of the signal flowing to the first coil flows is wound are shifted from each other in the circumferential direction.

A robot according to an application example of the present disclosure includes the rotary motor according to the application example of the present disclosure.

### BRIEF DESCRIPTION OF THE DRAWINGS

FIG. 1 is a longitudinal sectional view showing a schematic configuration of an axial gap motor, which is a rotary motor according to a first embodiment.

FIG. 2 is a sectional view of the axial gap motor shown in FIG. 1 taken along a surface orthogonal to a radial direction.

FIG. 3 is a block diagram showing an example of a driving circuit that supplies a driving signal to an axial gap motor of related art.

FIG. 4 is a block diagram showing an example of a driving circuit that supplies a driving signal to the axial gap motor according to the first embodiment.

FIG. 5 is a diagram showing force acting on permanent magnets shown in FIG. 2.

FIG. 6 is a diagram showing force acting on the permanent magnets at time t2 after elapse of a very short time from time t1 shown in FIG. 5.

FIG. 7 is a diagram showing force acting on the permanent magnets at time t3 after elapse of a very short time from the time t2 shown in FIG. 6.

FIG. 8 is a diagram showing force acting on the permanent magnets at time t4 after elapse of a very short time from the time t3 shown in FIG. 7.

FIG. 9 is a graph showing a change due to a rotation angle in cogging torque that occurs between a rotor and a first stator, a graph showing a change due to a rotation angle in cogging torque that occurs between the rotor and a second stator, and a graph showing a change due to a rotation angle in combined cogging torque obtained by combining the cogging torques in the axial gap motor according to the first embodiment.

FIG. 10 is a sectional view of an axial gap motor, which is a rotary motor according to a second embodiment, taken along a surface orthogonal to the radial direction.

FIG. 11 is a sectional view of an axial gap motor, which is a rotary motor according to a modification of the second embodiment, taken along a surface orthogonal to the radial direction.

FIG. 12 is a sectional view of an axial gap motor, which is a rotary motor according to a modification of the second embodiment, taken along a surface orthogonal to the radial direction.

FIG. 13 is a sectional view of an axial gap motor, which is a rotary motor according to a modification of the second embodiment, taken along a surface orthogonal to the radial direction.

FIG. 14 is a sectional view of an axial gap motor, which is a rotary motor according to a modification of the second embodiment, taken along a surface orthogonal to the radial direction.

FIG. 15 is a sectional view of an axial gap motor, which is a rotary motor according to a third embodiment, taken along a surface orthogonal to the radial direction.

FIG. 16 is a sectional view of an axial gap motor, which is a rotary motor according to a fourth embodiment, taken along a surface orthogonal to the radial direction.

FIG. 17 is a sectional view of a part of an axial gap motor, which is a rotary motor according to a fifth embodiment, taken along a surface orthogonal to a rotation axis.

FIG. 18 is a perspective view showing a robot according to a sixth embodiment.

FIG. 19 is a schematic diagram of the robot shown in FIG. 18.

FIG. 20 is a sectional view of the axial gap motor of the related art taken along a surface orthogonal to the radial direction.

FIG. 21 is a diagram showing force acting on permanent magnets shown in FIG. 20.

FIG. 22 is a diagram showing force acting on the permanent magnets at time t2 after elapse of a very short time from time t1 shown in FIG. 21.

FIG. 23 is a diagram showing force acting on the permanent magnets at time t3 after elapse of a very short time from the time t2 shown in FIG. 22.

FIG. 24 is a diagram showing force acting on the permanent magnets at time t4 after elapse of a very short time from the time t3 shown in FIG. 23.

FIG. 25 is a graph showing a change due to a rotation angle in cogging torque that occurs between a rotor and a first stator, a graph showing a change due to a rotation angle in cogging torque that occurs between the rotor and a second stator, and a graph showing a change due to a rotation angle in combined cogging torque obtained by combining the cogging torques in the axial gap motor of the related art.

### DESCRIPTION OF EXEMPLARY EMBODIMENTS

A rotary motor and a robot according to the present disclosure are explained in detail below with reference to embodiments shown in the accompanying drawings.

### 1. First Embodiment

First, a rotary motor according to a first embodiment is explained.

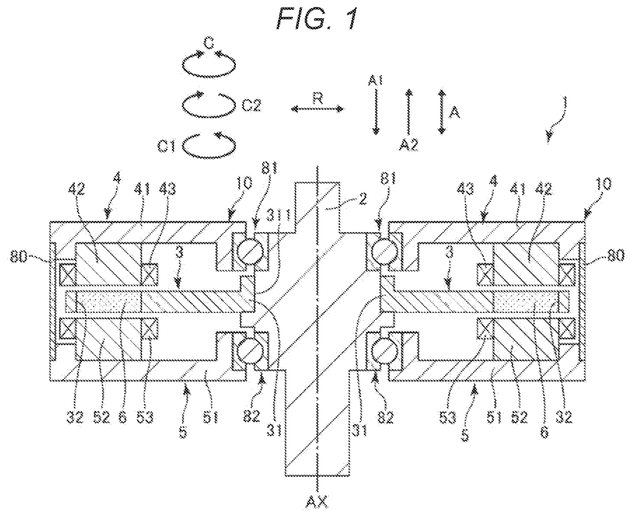

FIG. 1 is a longitudinal sectional view showing a schematic configuration of an axial gap motor, which is the rotary motor according to the first embodiment.

An axial gap motor 1 shown in FIG. 1 is a motor adopting a double stator structure. Specifically, the axial gap motor 1 shown in FIG. 1 includes a shaft 2 configured to rotate around a rotation axis AX, a rotor 3 fixed to the shaft 2 and configured to rotate around the rotation axis AX together with the shaft 2, and a pair of stators 4 and 5 disposed on both sides of the rotor 3 along the rotation axis AX. Such an axial gap motor 1 rotates the rotor 3 and the shaft 2 centering on the rotation axis AX and transmits a rotating force to a driving target member coupled to the shaft 2.

In the figures of this application, both directions along the rotation axis AX are referred to as “axial direction A”, both directions along the circumference of the rotor 3 are referred to as “circumferential direction C”, and both directions along the radius of the rotor 3 are referred to as “radial direction R”. In the axial direction A, a direction from the stator 4 to the stator 5 is represented as “axial direction A1” and a direction from the stator 5 to the stator 4 is represented as “axial direction A2”. Further, in the circumferential direction C, a counterclockwise direction viewed from the axial direction A1 is represented as “circumferential direction C1” and a clockwise direction viewed from the axial direction A1 is represented as “circumferential direction C2”.

The shaft 2 has a substantially columnar shape, the outer diameter of which is partially different, and is solid. Consequently, mechanical strength of the shaft 2 is improved. However, the shaft 2 may be hollow.

The rotor 3 having a disk shape is fixed to the shaft 2 concentrically with the shaft 2. The rotor 3 includes a frame 31 and a plurality of permanent magnets 6 disposed in the frame 31.

The stators 4 and 5 are attached to the shaft 2 via bearings 81 and 82. The shaft 2 and the rotor 3 are supported by the bearings 81 and 82 to be rotatable with respect to a motor case 10 configured by combining the stators 4 and 5 using a side surface case 80. In this embodiment, a radial ball bearing is used as the bearings 81 and 82. However, the bearings 81 and 82 are not limited to the radial ball bearing. For example, various bearings such as an axial ball bearing, an angular ball bearing, and a taper roller bearing can be used.

As shown in FIG. 1, the stators 4 and 5 are disposed to sandwich the rotor 3 from both sides in the axial direction A. Specifically, the stator 4 is disposed on the upper side of the rotor 3 via a gap and the stator 5 is disposed on the lower side of the rotor 3 via a gap.

The stator 4 includes an annular case 41 disposed concentrically with the shaft 2, a plurality of stator cores 42 supported on the surface in the axial direction A1 of the case 41 and disposed to be opposed to the permanent magnets 6, and a plurality of coils 43 disposed in the stator cores 42.

The stator 5 includes an annular case 51 disposed concentrically with the shaft 2, a plurality of stator cores 52 supported on the surface in the axial direction A2 of the case 51 and disposed to be opposed to the permanent magnets 6, and a plurality of coils 53 disposed in the stator cores 52.

The configurations of the stators 4 and 5 are further explained below. However, since the stators 4 and 5 have the same configuration, the stator 4 is representatively explained below. Explanation about the stator 5 is omitted.

The plurality of stator cores 42 are arranged side by side at equal intervals along the circumferential direction C. The stator cores 42 are made of any one of various magnetic materials such as a laminated body of electromagnetic steel plates and a pressurized powder body of magnetic powder, in particular, a soft magnetic material.

The coils 43 disposed in the stator cores 42 are wound around the outer circumferences of the stator cores 42. Electromagnets are configured by the stator cores 42 and the coils 43.

The axial gap motor 1 includes a driving circuit explained below. The coils 43 are coupled to the driving circuit. When a signal of one phase in a three-phase alternating current is supplied to the coils 43, magnetic fluxes are generated from the electromagnets and force is generated between the electromagnets and the permanent magnets 6 opposed to the electromagnets. The force acts as a driving force and the rotor 3 rotates around the rotation axis AX.

Subsequently, the configuration of the rotor 3 is explained.

The rotor 3 includes, as explained above, the frame 31 fixed to the shaft 2 and the permanent magnets 6 disposed in the frame 31.

The frame 31 includes, as shown in FIG. 1, a through-hole 311 piercing through the frame 31 along the rotation axis AX and a plurality of through-holes 32 arranged side by side along the circumferential direction C. The permanent magnets 6 are inserted into the through-holes 32. The number of the permanent magnets 6 is set as appropriate according to the number of phases and the number of poles of the axial gap motor 1. Examples of the permanent magnets 6 include a neodymium magnet, a ferrite magnet, a samarium cobalt magnet, an alnico magnet, and a bond magnet. However, the permanent magnets 6 are not limited to these magnets.

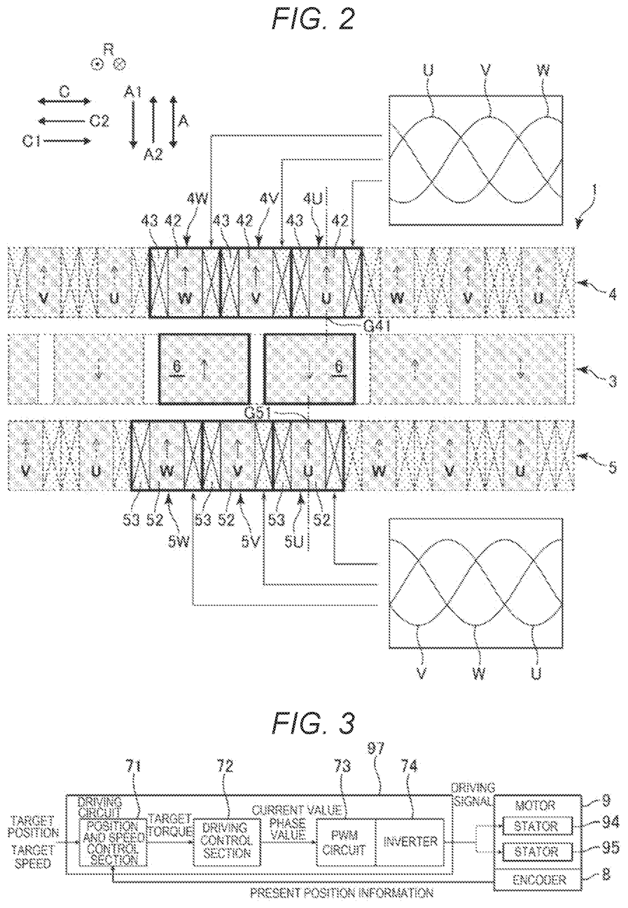

FIG. 2 is a sectional view of the axial gap motor 1 shown in FIG. 1 taken along a surface orthogonal to the radial direction R. In FIG. 2 and figures referred to below, a part of the structure of the axial gap motor 1 is omitted.

The rotor 3 shown in FIG. 2 includes, as explained above, the plurality of permanent magnets 6 arranged side by side along the circumferential direction C. The permanent magnets 6 shown in FIG. 2 are magnetized such that N poles and S poles are alternately disposed along the circumferential direction C. In FIG. 2, directions of magnetization of the permanent magnets 6 are indicated by arrows. Among the plurality of permanent magnets 6 shown in FIG. 2 and the figures referred to below, the permanent magnets 6 of attention are indicated by a thick line.

The stator 4 shown in FIG. 2 includes a plurality of stator cores 42 arranged side by side along the circumferential direction C and the coil 43 wound around each of the stator cores 42. Further, the stator 5 shown in FIG. 2 includes a plurality of stator cores 52 arranged side by side along the circumferential direction C and the coil 53 wound around each of the stator cores 52.

The stator 4 shown in FIG. 2 includes a U-phase slot 4U, a V-phase slot 4V, and a W-phase slot 4W. The stator 5 shown in FIG. 2 includes a U-phase slot 5U, a V-phase slot 5V, and a W-phase slot 5W.

The U-phase slot 4U and the U-phase slot 5U are shifted from each other in the circumferential direction C. More specifically, a center of gravity G41 of the stator core 42 included in the U-phase slot 4U and a center of gravity G51 of the stator core 52 included in the U-phase slot 5U are shifted from each other in the circumferential direction C. The center of gravity G41 of the stator core 42 is a geometrical center of the stator core 42 in a plan view of the stator core 42 in the axial direction A2. The center of gravity G51 of the stator core 52 is a geometrical center of the stator core 52 in a plan view of the stator core 52 in the axial direction A1.

The V-phase slot 4V and the V-phase slot 5V are also shifted from each other in the circumferential direction C. Although not shown in FIG. 2, the center of gravity of the stator core 42 included in the V-phase slot 4V and the center of gravity of the stator core 52 included in the V-phase slot 5V are shifted from each other in the circumferential direction C.

Further, the W-phase slot 4W and the W-phase slot 5W are also shifted from each other in the circumferential direction C. Although not shown in FIG. 2, the center of gravity of the stator core 42 included in the W-phase slot 4W and the center of gravity of the stator core 52 included in the W-phase slot 5W are shifted from each other in the circumferential direction C.

In FIG. 2 and the figures referred to below, a direction of winding wires of the coils included in the slots is indicated by arrows. Among the plurality of slots shown in FIG. 2 and the figures referred to below, slots of attention are indicated by a thick line.

The slots of attention in FIG. 2 are one unit of the U-phase slot 4U, the V-phase slot 4V, and W-phase slot 4W continuously arranged side by side. In the stators 4 and 5, the slots of this unit are repeatedly disposed along the circumferential direction C.

The permanent magnets 6 of attention in FIG. 2 are one unit formed by two permanent magnets 6 adjacent to each other. In the rotor 3, this unit is repeatedly disposed along the circumferential direction C.

In the axial gap motor 1 according to this embodiment, it is preferable to shift phases of a driving signal of a three-phase alternating current supplied to the stator 4 and a driving signal of a three-phase alternating current supplied to the stator 5. A circuit for shifting the phases of the driving signals is explained below. It is not essential to shift the phases of the driving signals. For example, when a separation angle (a mechanical angle) between the stators 4 and 5 is small, although an effect slightly decreases, driving signals, phases of which are not shifted, may be supplied. Even in this case, an effect of suppressing cogging torque is obtained.

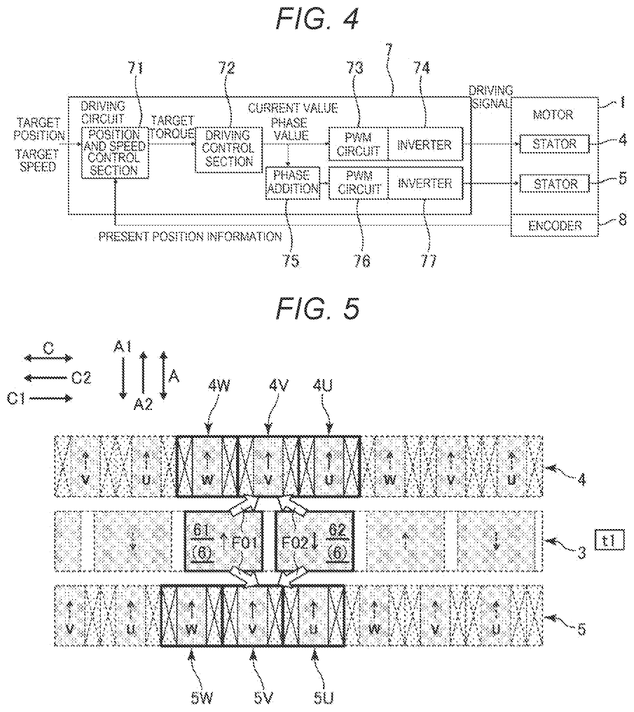

FIG. 3 is a block diagram showing an example of a driving circuit that supplies a driving signal to the axial gap motor 9 of the related art. FIG. 4 is a block diagram showing an example of a driving circuit that supplies a driving signal to the axial gap motor 1 according to the first embodiment.

A driving circuit 97 shown in FIG. 3 is a circuit for supplying a driving signal to the axial gap motor 9 of the related art. The driving circuit 97 includes a position and speed control section 71, a driving control section 72, a PWM circuit 73, and an inverter circuit 74. PWM is an abbreviation of pulse width modulation.

When a target position and a target speed for a rotor 93 of the axial gap motor 9 are input from a not-shown external control device, the position and speed control section 71 calculates target torque based on the target position, the target speed, and present position information explained below and outputs the target torque to the driving control section 72. The driving control section 72 calculates a current value and a phase value based on the target torque and outputs the current value and the phase value to the PWM circuit 73. The PWM circuit 73 generates an inverter control signal for controlling the inverter circuit 74. The inverter circuit 74 outputs a driving signal of a three-phase alternating current based on the inverter control signal. The driving signal is supplied to both of stators 94 and 95, whereby the axial gap motor 9 is driven. An encoder 8 is coupled to the axial gap motor 9. The present position information acquired by the encoder 8 is fed back to the position and speed control section 71.

In contrast, a driving circuit 7 shown in FIG. 4 is an example of a circuit for supplying a driving signal to the axial gap motor 1 according to the first embodiment. The driving circuit 7 includes a phase addition circuit 75, a PWM circuit 76, and an inverter circuit 77 in addition to the position and speed control section 71, the driving control section 72, the PWM circuit 73, and the inverter circuit 74 explained above. A driving signal output from the inverter circuit 74 is supplied to only the stator 4.

On the other hand, in the driving circuit 7 shown in FIG. 4, a current value and a phase value output from the driving control section 72 are input to, in addition to the PWM circuit 73, the phase addition circuit 75 that is parallel to the PWM circuit 73. The phase addition circuit 75 performs an arithmetic operation for changing the phase value. As an example, the phase addition circuit 75 delays a phase by 30° in an electrical angle. The PWM circuit 76 calculates an inverter control signal based on the current value and the phase value. The inverter circuit 77 outputs a driving signal of a three-phase alternating current based on the inverter control signal. The driving signal output from the inverter circuit 77 is supplied to the stator 5.

In this way, in this embodiment, the position of the slots of the same phase are shifted from each other in the circumferential direction C between the stators 4 and 5 and the phases of the driving signals supplied to the stators 4 and 5 are shifted from each other according to necessity. Specifically, length equivalent to 1/12 of a repetition cycle of the unit formed by the U-phase slot 4U, the V-phase slot 4V, and the W-phase slot 4W of the stator 4 is shifted between the stators 4 and 5. The electric angle of 30° equivalent to the length is a phase difference between the driving signals supplied to the stators 4 and 5. Consequently, cogging torque can be suppressed. A reason why such effects are obtained is explained below.

FIG. 5 is a diagram showing force acting on the permanent magnets 6 shown in FIG. 2. In FIG. 5, a positional relation between the rotor 3 and the stators 4 and 5 at a certain instance (time t1) is shown. At the time t1, the middle of the permanent magnets 61 and 62 adjacent to each other is located in the center of the V-phase slot 4V. The position of the slot of the same phase is shifted between the stators 4 and 5. In this embodiment, the phases supplied to the stators 4 and 5 are shifted according to an amount of the shift. Therefore, in FIG. 5, force F01 for directing the permanent magnet 61 to the circumferential direction C1 acts and force F02 for directing the permanent magnet 62 to the circumferential direction C2 acts. Since the forces F01 and F02 face opposite directions each other and the intensities of the forces F01 and F02 are equal to each other, at the time t1, the force F01 and the force F02 are balanced in the circumferential direction C. Therefore, at the time t1, cogging torque involved in the difference between the force F01 and the force F02 hardly occurs. In the figures referred to below, two permanent magnets 6 of attention are particularly represented as permanent magnets 61 and 62.

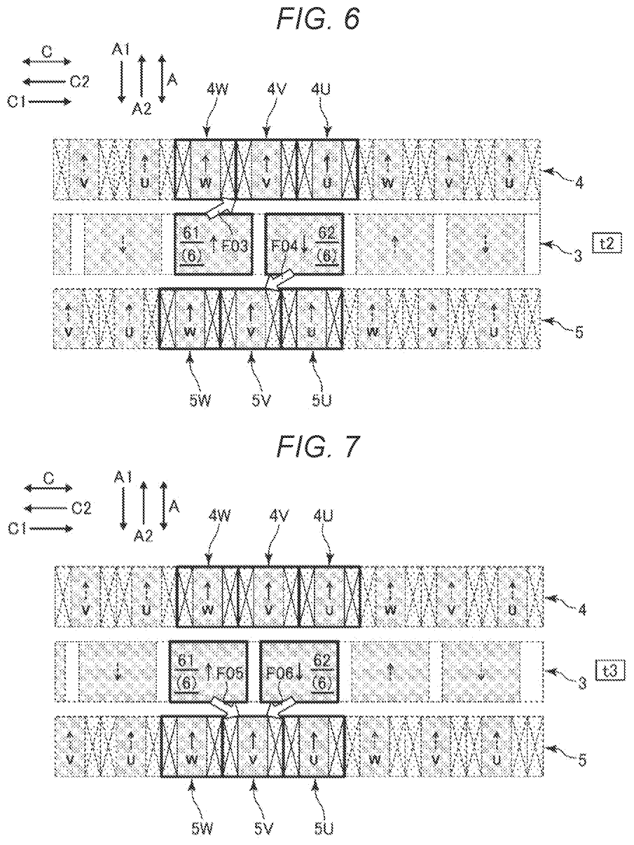

FIG. 6 is a diagram showing force acting on the permanent magnets 6 at time t2 after elapse of a very short time from the time t1 shown in FIG. 5. At time t2, compared with the time t1, the rotor 3 slightly rotates in the circumferential direction C2. In FIG. 6, force F03 for directing the permanent magnet 61 to the circumferential direction C1 acts and force F04 for directing the permanent magnet 62 to the circumferential direction C2 acts. On the other hand, in FIG. 6, the middle of the permanent magnets 61 and 62 is located in the middle of the V-phase slot 4V and the V-phase slot 5V. Therefore, the force F03 and the force F04 are balanced in the circumferential direction C. As a result, at the time t2 as well, cogging torque is suppressed.

FIG. 7 is a diagram showing force acting on the permanent magnets 6 at time t3 after elapse of a very short time from the time t2 shown in FIG. 6. At the time t3, compared with the time t2, the rotor 3 further slightly rotates in the circumferential direction C2. In FIG. 7, force F05 for directing the permanent magnet 61 to the circumferential direction C1 acts and force F06 for directing the permanent magnet 62 to the circumferential direction C2 acts. On the other hand, in FIG. 7, the middle of the permanent magnets 61 and 62 is located in the center of the V-phase slot 5V. Therefore, the force F05 and the force F06 are balanced in the circumferential direction C. As a result, at the time t3 as well, cogging torque hardly occurs.

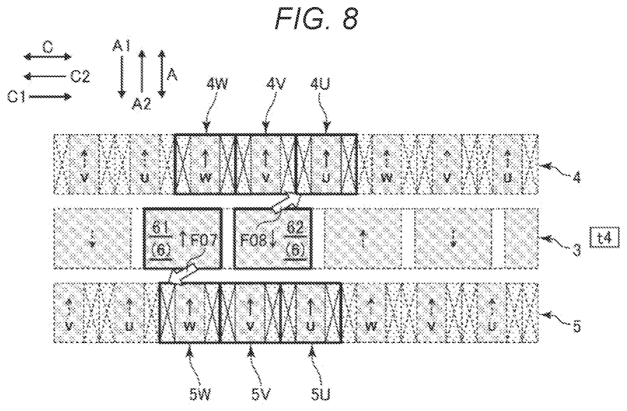

FIG. 8 is a diagram showing force acting on the permanent magnets 6 at time t4 after elapse of a very short time from the time t3 shown in FIG. 7. At the time t4, compared with the time t3, the rotor 3 further slightly rotates in the circumferential direction C2. In FIG. 8, force F07 for directing the permanent magnet 61 to the circumferential direction C2 acts and force F08 for directing the permanent magnet 62 to the circumferential direction C1 acts. On the other hand, in FIG. 8, the middle of the permanent magnets 61 and 62 is located in the middle of the W-phase slot 4W and the V-phase slot 5V. Therefore, the force F07 and the force F08 are balanced in the circumferential direction C. As a result, at the time t4 as well, cogging torque is suppressed.

A situation represented by the time t1 to the time t4 explained above repeatedly occurs according to the rotation of the rotor 3. Therefore, in the axial gap motor 1 shown in FIG. 2, large torque fluctuation due to cogging torque is suppressed.

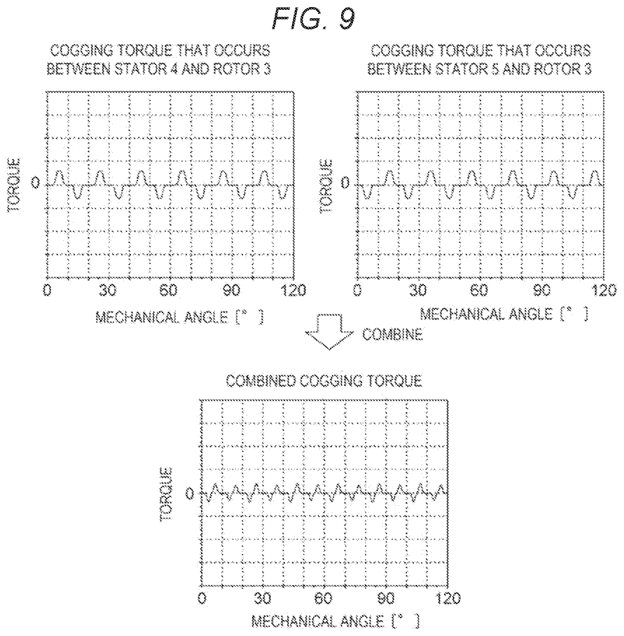

FIG. 9 is a graph showing a change due to a rotation angle in cogging torque that occurs between the rotor 3 and the stator 4, a graph showing a change due to a rotation angle in cogging torque that occurs between the rotor 3 and the stator 5, and a graph showing a change due to a rotation angle in combined cogging torque obtained by combining the cogging torques in the axial gap motor 1 according to the first embodiment.

As shown in FIG. 9, a relation in which crests and bottoms of torque overlap and weaken each other occurs between cogging torque that occurs between the rotor 3 and the stator 4 and cogging torque that occurs between the rotor 3 and the stator 5. This is because phases of torque fluctuation are shifted in both of the cogging torques. As a result, large torque fluctuation is suppressed in the combined cogging torque shown in FIG. 9.

In contrast, as a comparative example, the axial gap motor of the related art is explained with reference to schematic diagrams.

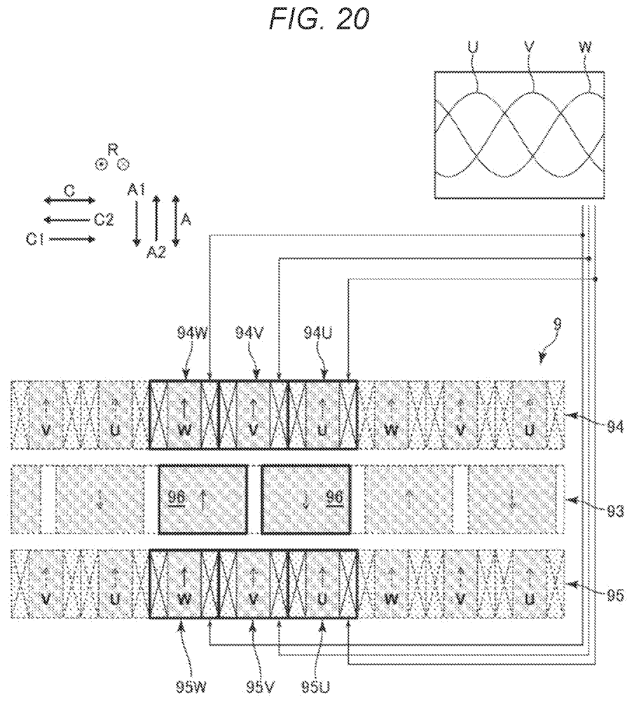

FIG. 20 is a sectional view of the axial gap motor of the related art taken along a surface orthogonal to the radial direction.

The axial gap motor 9 shown in FIG. 20 adopts a so-called double stator structure including the rotor 93 that rotates around the rotation axis AX and the stators 94 and 95 provided on both sides via the rotor 93. In FIG. 20, both directions along the rotation axis AX are referred to as “axial direction A”, both directions along the circumference of the rotor 93 are referred to as “circumferential direction C”, and both directions along the radius of the rotor 93 are referred to as “radial direction R”. In the axial direction A, a direction from the stator 94 to the stator 95 is represented as “axial direction A1” and a direction from the stator 95 to the stator 94 is represented as “axial direction A2”. Further, in the circumferential direction C, the right direction in FIG. 20 is represented as “circumferential direction C1” and the left direction in FIG. 20 is represented as “circumferential direction C2”.

The rotor 93 shown in FIG. 20 includes a plurality of permanent magnets 96 arranged side by side along the circumferential direction C. The permanent magnets 96 are magnetized such that N poles and S poles are alternately disposed along the circumferential direction C. In FIG. 20, directions of magnetization of the permanent magnets 96 are indicated by arrows. Among the plurality of permanent magnets 96 shown in FIG. 20 and the figures referred to below, the permanent magnets 96 of attention are indicated by a thick line.

The stator 94 shown in FIG. 20 includes a U-phase slot 94U, a V-phase slot 94V, and a W-phase slot 94W. The stator 95 shown in FIG. 20 includes a U-phase slot 95U, a V-phase slot 95V, and a W-phase slot 95W. The U-phase slot 94U and the U-phase slot 95U are present in the same position in the circumferential direction C. The V-phase slot 94V and the V-phase slot 95V are present in the same position in the circumferential direction C. Further, the W-phase slot 94W and the W-phase slot 95W are present in the same position in the circumferential direction C. In FIG. 20, a direction of coils included in the slots is indicated by arrows. Among the slots shown in FIG. 20 and the figures referred to below, slots of attention are indicated by a thick line.

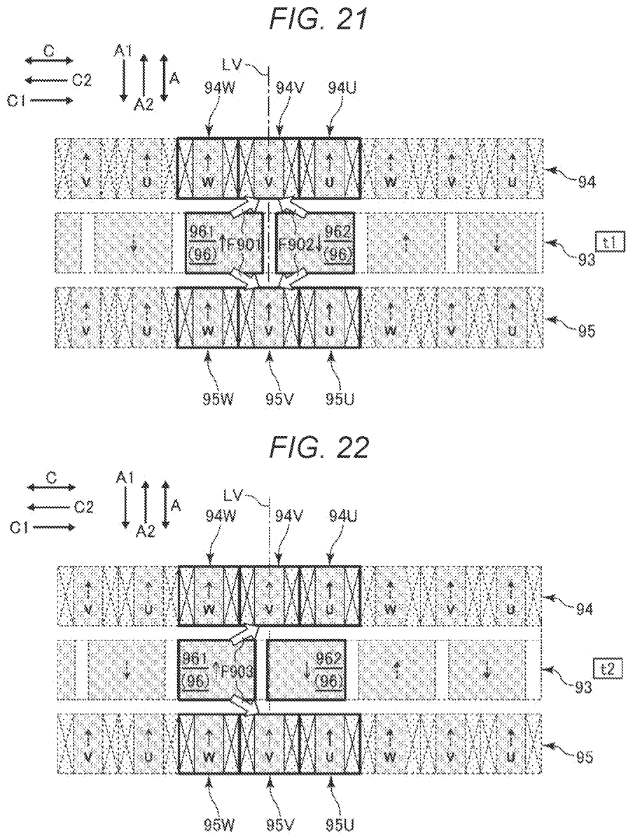

FIG. 21 is a diagram showing force acting on the permanent magnets 96 shown in FIG. 20. In FIG. 21, a positional relation between the rotor 93 and the stators 94 and 95 at a certain instance (time t1) is shown. At the time t1, a straight line LV connecting the center of the V-phase slot 94V and the center of the V-phase slot 95V passes the middle of the permanent magnets 96 adjacent to each other. In FIG. 21, two permanent magnets 96, the middle of which the straight line LV passes, are particularly represented as permanent magnets 961 and 962.

At the time t1 shown in FIG. 21, force F901 for attracting the permanent magnet 961 to the V-phase slots 94V and 95V and directing the permanent magnet 961 to the circumferential direction C1 acts on the permanent magnet 961 and force F902 for attracting the permanent magnet 962 to the V-phase slots 94V and 95V and directing the permanent magnet 962 to the circumferential direction C2 acts on the permanent magnet 962. Since the forces F901 and F902 face the opposite directions each other and the intensities of the force F901 and the force F902 are equal to each other, at the time t1, the force F901 and the force F902 are balanced in the circumferential direction C. Therefore, at the time t1, cogging torque involved in the difference between the force F901 and the force F902 hardly occurs.

FIG. 22 is a diagram showing force acting on the permanent magnets 96 at time t2 after elapse of a very short time from the time t1 shown in FIG. 21. At the time t2, compared with the time t1, the rotor 93 slightly rotates in the circumferential direction C2. In FIG. 22, the straight line LV connecting the center of the V-phase slot 94V and the center of the V-phase slot 95V passes a position shifted from the middle of the permanent magnets 961 and 962. At this time, the permanent magnet 961 is attracted to the V-phase slots 94V and 95V. The permanent magnet 962 is attracted from each of the V-phase slots 94V and 95V and the U-phase slots 94U and 95U. Therefore, at the time t2, forces are unbalanced. Force F903 for directing the rotor 93 to the circumferential direction C1 acts. On the other hand, force for directing the rotor 93 to the circumferential direction C2 is relatively weak. Therefore, at the time t2, cogging torque occurs in the circumferential direction C1.

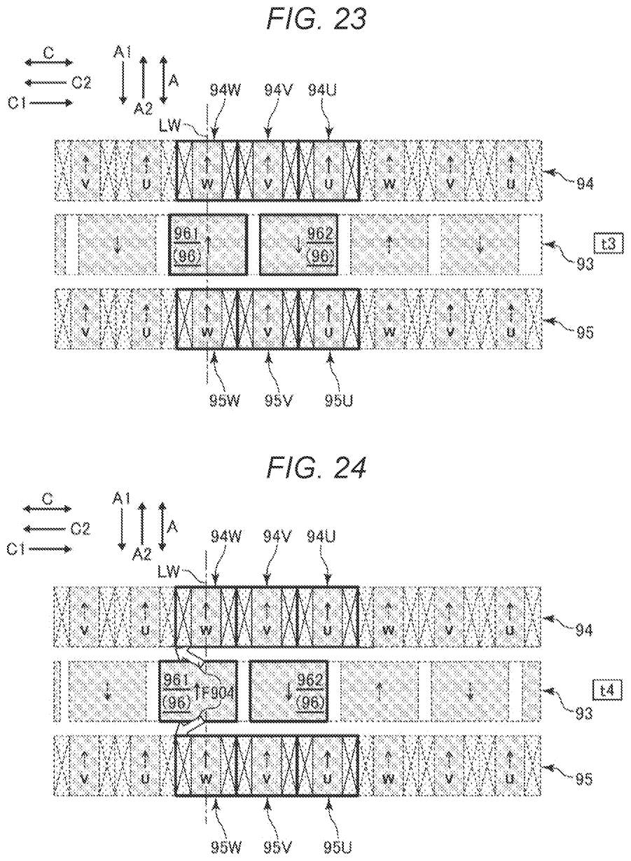

FIG. 23 is a diagram showing force acting on the permanent magnets 96 at time t3 after elapse of a very short time from the time t2 shown in FIG. 22. At the time t3, compared with the time t2, the rotor 93 further slightly rotates in the circumferential direction C2. In FIG. 23, a straight line LW passes the center of the permanent magnet 961. When a straight line passing the center of the permanent magnet 962 and parallel to the axial direction A is assumed, the positions of the V-phase slots 94V and 95V and the U-phase slots 94U and 95U are symmetrical with respect to the straight line. Therefore, at the time t3, since forces in the opposite directions in the circumferential direction C act on the permanent magnets 961 and 962 and cancel each other, force does not act on the permanent magnets 96. Therefore, at the time t3, cogging torque hardly occurs.

FIG. 24 is a diagram showing force acting on the permanent magnets 96 at time t4 after elapse of a very short time from the time t3 shown in FIG. 23. At the time t4, compared with the time t3, the rotor 93 further slightly rotates in the circumferential direction C2. In FIG. 24, the straight line LW passes a position shifted from the center of the permanent magnet 961. The positions of the V-phase slots 94V and 95V and the U-phase slots 94U and 95U are not symmetrical with respect to the straight line passing the center of the permanent magnet 962 and parallel to the axial direction A. At this time, the permanent magnet 961 is attracted to the U-phase slots. The permanent magnet 962 is attracted from each of the V-phase slots 94V and 95V and the U-phase slots 94U and 95U. Therefore, at the time t4, forces are unbalanced. Force F904 for directing the rotor 93 to the circumferential direction C2 acts. On the other hand, force for directing the rotor 93 to the circumferential direction C1 is relatively weak. Therefore, at the time t4, cogging torque occurs in the circumferential direction C2.

A situation represented by the time t1 to the time t4 explained above repeatedly occurs according to the rotation of the rotor 93. Therefore, in the axial gap motor 9 of the related art shown in FIG. 20, cogging torque in which torque periodically fluctuates occurs.

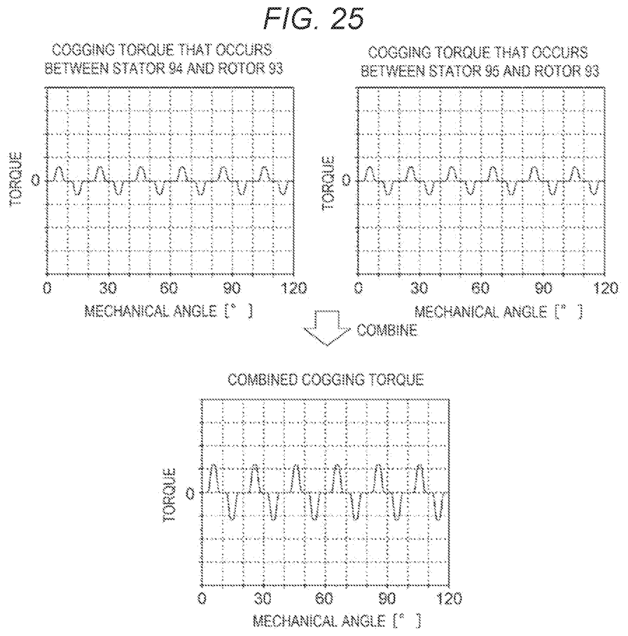

FIG. 25 is a graph showing a change due to a rotation angle in cogging torque that occurs between the rotor 93 and the stator 94, a graph showing a change due to a rotation angle in cogging torque that occurs between the rotor 93 and the stator 95, and a graph showing a change due to a rotation angle in combined cogging torque obtained by combining the cogging torques in the axial gap motor 9 of the related art.

In the axial gap motor 9 shown in FIG. 20, as explained above, the U-phase slot 94U and the U-phase slot 95U are present in the same position in the circumferential direction C. The same applies to the other slots. Therefore, between cogging torque that occurs between the rotor 93 and the stator 94 and cogging torque that occurs between the rotor 93 and the stator 95, a relation in which the cogging torques intensify each other occurs. As a result, the combined cogging torque shown in FIG. 25 involves large torque fluctuation corresponding to transition of a rotation angle.

As explained above, the axial gap motor 1, which is the rotary motor according to this embodiment, includes the stator 4 (a first stator), the stator 5 (a second stator), and the rotor 3 disposed between the stator 4 and the stator 5 via the gap. The stator 4 includes the plurality of stator cores (a first core) and the coil 43 (a first coil) wound around each of the stator cores 42. A signal of any one of the U phase (a first phase), the V phase (a second phase), and the W phase (a third phase) forming the three-phase alternating current flows to the coil 43. The stator 5 includes the plurality of stator cores 52 (a second core) and the coil 53 (a second coil) wound around each of the stator cores 52. A signal of any one of the U phase, the V phase, and the W phase forming the three-phase alternating current flows to the coil 53. The rotor 3 includes the plurality of permanent magnets 6 arranged side by side in the circumferential direction C around the rotation axis AX. The center of gravity G41 of the stator core 42, around which the coil 43 to which a signal of the U phase flows is wound, and the center of gravity G51 of the stator core 52, around which the coil 53 to which a signal of the U phase (a signal of the same phase as the phase of the signal flowing to the coil 43) flows is wound, are shifted from each other in the circumferential direction C.

With such a configuration, cogging torque that occurs between the rotor 3 and the stator 4 and cogging torque that occurs between the rotor 3 and the stator 5 can be cancelled each other. Consequently, large torque fluctuation is suppressed in combined cogging torque.

The rotary motor according to this embodiment is the axial gap motor 1 in which the gaps are provided between the rotor 3 and the stators 4 and 5 in the axial direction. Since the axial gap motor 1 has structure easily reduced in thickness in the axial direction A, it is easy to flatten the axial gap motor 1. Therefore, it is possible to easily reduce the size of a machine in which the axial gap motor 1 is incorporated.

### 2. Second Embodiment

A rotary motor according to a second embodiment is explained.

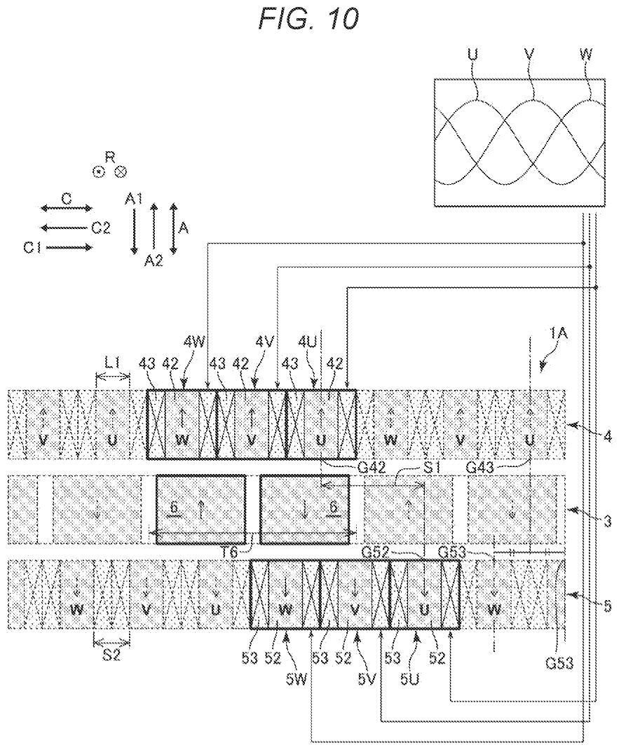

FIG. 10 is a sectional view of an axial gap motor 1A, which is the rotary motor according to the second embodiment, taken along a surface orthogonal to the radial direction R.

The second embodiment is explained below. In the following explanation, differences from the first embodiment are mainly explained. Explanation about similarities to the first embodiment is omitted. In FIG. 10, the same components as the components in the first embodiment are denoted by the same reference numerals and signs.

The second embodiment is the same as the first embodiment except that an amount of shifting the positions of slots of the same phase from each other in the circumferential direction C between the stators 4 and 5 is different.

In the axial gap motor 1A shown in FIG. 10, length equivalent to a half of a repetition cycle of a unit formed by the U-phase slot 4U, the V-phase slot 4V, and the W-phase slot 4W of the stator 4 is set as a shift amount. That is, between the stators 4 and 5 shown in FIG. 10, a shift amount S1 between a center of gravity G42 of the stator core 42 (the first core) and a center of gravity G52 of the stator core 52 (the second core) in the circumferential direction C is equal to a half of a cycle T6 of the permanent magnets 6 in the circumferential direction C. In other words, the shift amount S1 is equal to a half of the length of slots of one unit in the circumferential direction C.

In the axial gap motor 1A shown in FIG. 10, length L1 of the stator core 42 (the first core) in the circumferential direction C is preferably equal to or larger than an interval S2 between the stator cores 52 (the second cores) adjacent to each other in the circumferential direction C. Further, in the axial gap motor LA, the length of the stator core 52 in the circumferential direction C is preferably equal to or larger than an interval between the stator cores 42 adjacent to each other in the circumferential direction C.

With such a configuration, for example, the following relation always holds: when the axial gap motor 1A is viewed from the axial direction A, the stator core 52 of the stator 5 is located between the stator cores 42 of the stator 4 and, conversely, the stator core 42 of the stator 4 is located between the stator cores 52 of the stator 5. That is, one or both of the stator core 42 and the stator core 52 are opposed to the rotor 3 at all mechanical angles. As a result, it is possible to always maintain a positional relation for offsetting cogging torques that occur when the permanent magnets 6 and the stator cores 42 and 52 attract each other. A concept of the shift amount S1 being equal to a half of the cycle T6 includes a shift in a degree of a manufacturing error, for example, a shift of 3% or less of the cycle T6.

In the axial gap motor 1A shown in FIG. 10, in particular, the length L1 is set to be equal to the interval S2. Further, in the axial gap motor 1A shown in FIG. 10, the length of the stator core 52 in the circumferential direction C is set to be equal to the interval between the stator cores 42 adjacent to each other in the circumferential direction C.

In this case, it is easy to design the rotor 3 such that only one of the stator core 42 and the stator core 52 is opposed to the rotor 3 at all mechanical angles. Therefore, it is also easy to design a facing area of the permanent magnets 6 and the stator cores 42 and 53 to be fixed. As a result, it is easy to always maintain a positional relation in which cogging torques can be offset. A concept of the length L1 and the interval S2 being equal includes a shift in a degree of a manufacturing error, for example, a shift of 3% or less of the interval S2.

In the axial gap motor 1A shown in FIG. 10, the direction of the coil 43 (the first coil) of the stator 4 and the direction of the coil 53 (the second coil) of the stator 5 are opposite to each other.

On the other hand, in this embodiment, as explained above, the shift amount S1 of the stator cores 42 and 52 is equal to a half of the cycle T6. Therefore, since the directions of the coils 43 and 53 are opposite to each other, signals having the same waveform can be used as driving signals supplied to the coils 43 and 45. Therefore, in this embodiment, it is unnecessary to use the phase addition circuit 75 shown in FIG. 4 in a driving circuit. As a result, it is possible to easily achieve a reduction in the cost of the driving circuit.

The directions of the coils 43 and 53 being opposite to each indicates that the directions of signals flowing in the coils 43 and 53 are set opposite to each other. Therefore, in the coils 43 and 53 used in this embodiment, winding wires configuring the coils do not need to be differentiated from each other. Coupling of the winding wires and the driving circuit only has to be switched. Accordingly, in this embodiment, the same coil components can be used. In that viewpoint as well, it is easy to achieve a reduction in the cost of the axial gap motor LA.

In the axial gap motor 1A shown in FIG. 10, when viewed from the axial direction A (a position along the rotation axis AX), a center of gravity G43 of the stator core (the first core) is located in the middle of a centers of gravity G53 of the stator cores 52 adjacent to each other in the circumferential direction C. Further, in the axial gap motor LA shown in FIG. 10, when viewed from a position along the rotation axis AX, the center of gravity of the stator core (the second core) is located in the middle of the centers of gravity of the stator cores 42 adjacent to each other in the circumferential direction C.

With such a configuration, only one of the stator core 42 and the stator core 52 is opposed to the rotor 3 at all mechanical angles. Therefore, it is possible to always fix a facing area of the permanent magnet 6 and the stator cores 42 and 52. As a result, it is possible to always maintain a positional relation in which cogging torques can be more surely offset. A concept of the middle between the centers of gravity G53 includes a shift in a degree of a manufacturing error, for example, a shift equal to or smaller than 3% of the distance between the centers of gravity G53.

In the second embodiment explained above, the same effects as the effects in the first embodiment are obtained.

### 3. Modifications

Rotary motors according to modifications of the second embodiment are explained.

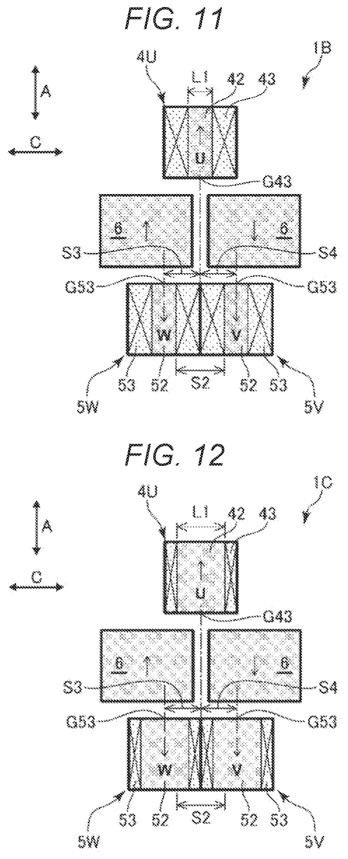

FIGS. 11 to 14 are sectional views of axial gap motors 1B to 1E, which are rotary motors according to the modifications of the second embodiment, taken along surfaces orthogonal to the radial direction R. In FIGS. 11 to 14, only a part of slots and a part of permanent magnets are extracted and illustrated.

The modifications are explained below. In the following explanation, differences from the second embodiment are mainly explained. Explanation about similarities to the second embodiment is omitted. In FIGS. 11 to 14, the same components as the components in the second embodiment are denoted by the same reference numerals and signs.

In the axial gap motor 1A shown in FIG. 10 explained above, the length L1 of the stator core 42 in the circumferential direction C is set to be equal to the interval S2 between the stator cores 52 adjacent to each other in the circumferential direction C.

In contrast, in the axial gap motor 1B shown in FIG. 11, the length L1 of the stator core 42 in the circumferential direction C is set smaller than the interval S2 between the stator cores 52 adjacent to each other in the circumferential direction C. In this case, the effect of at least one of the stator core 42 and the stator core 52 being opposed to the rotor 3 at all mechanical angles is not obtained.

In the axial gap motor 1C shown in FIG. 12, the length L1 is set to be larger than the interval S2. Even in that case, the effect of at least one of the stator core 42 and the stator core 52 being opposed to the rotor 3 at all mechanical angles is obtained. On the other hand, timing when both of the stator cores 42 and 52 are opposed to the rotor 3 occurs. In this case, compared with the axial gap motor 1A, since forces are easily unbalanced, there is room of occurrence of cogging torque.

Further, in the axial gap motors 1B and 1C, as in the axial gap motor LA, when viewed from the axial direction A (the position along the rotation axis AX), the center of gravity G43 of the stator core 42 is located in the middle of the centers of gravity G53 of the stator core 52 adjacent to each other in the circumferential direction C. That is, a distance S3 and a distance S4 shown in FIG. 11 and FIG. 12 are set to be equal. Therefore, as in the axial gap motor 1A, it is possible to always maintain a positional relation in which cogging torques are easily offset.

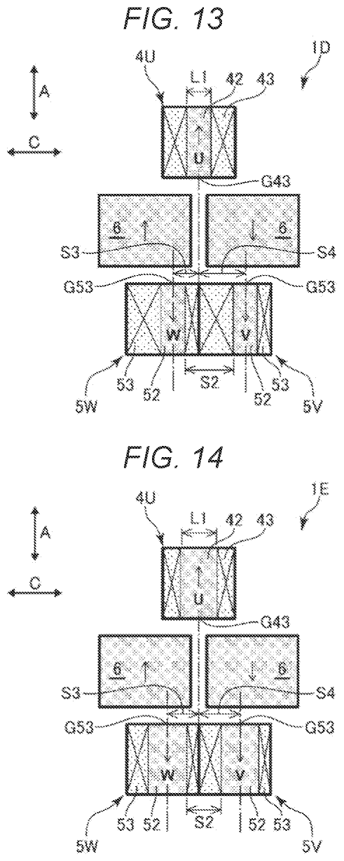

On the other hand, in the axial gap motor 1D shown in FIG. 13, when viewed from the axial direction A (the position along the rotation axis AX), the center of gravity G43 of the stator core 42 is not located in the middle of the centers of gravity G53 of the stator cores 52 adjacent to each other in the circumferential direction C. That is, the distance S3 and the distance S4 shown in FIG. 13 are set to be different. In the axial gap motor 1D, the length L1 is set to be smaller than the interval S2. In this case, a state occurs in which both of the stator core 42 and the stator core 52 are not opposed to the rotor 3 at a part of mechanical angles.

In the axial gap motor 1E shown in FIG. 14 as well, the distance S3 and the distance S4 are set to be different. On the other hand, in the axial gap motor 1E, the length L1 is set to be equal to the interval S2. In this case as well, a state could occur in which both of the stator core 42 and the stator core 52 are not opposed to the rotor 3 at a part of the mechanical angles.

Therefore, in the axial gap motors 1D and 1E, an effect of making it easy to always maintain a positional relation for offsetting cogging torques is less easily obtained.

Accordingly, the axial gap motor 1A explained above is useful in a viewpoint of particularly suppressing occurrence of cogging torque.

In the modifications explained above, as in the second embodiment, an effect of shifting the positions of the slots in the same phase from each other in the circumferential direction C between the stators 4 and 5 is obtained.

### 4. Third Embodiment

A rotary motor according to a third embodiment is explained.

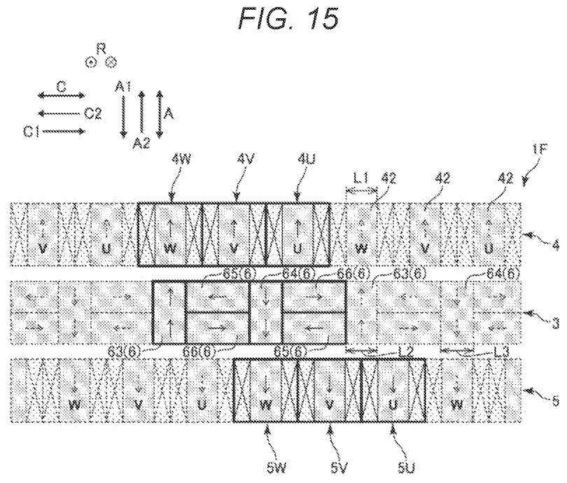

FIG. 15 is a sectional view of an axial gap motor 1F, which is the rotary motor according to the third embodiment, taken along a surface orthogonal to the radial direction R.

The third embodiment is explained below. In the following explanation, differences from the second embodiment are mainly explained. Explanation about similarities to the second embodiment is omitted. In FIG. 15, the same components as the components in the second embodiment are denoted by the same reference numerals and signs.

In the second embodiment explained above, the permanent magnets 6 included in the rotor 3 are magnetized such that the N poles and the S poles are alternately disposed along the circumferential direction C. Such an array of the permanent magnets 6 is referred to as “normal magnet array”. In contrast, in this embodiment, the permanent magnets 6 included in the rotor 3 are magnetized to be arrayed in a “Halbach magnet array”. The permanent magnets 6 of the Halbach magnet array include, as shown in FIG. 15, a main magnetic pole magnet 63, a direction of magnetization of which is the axial direction A2, a main magnetic pole magnet 64, a direction of magnetization of which is the axial direction A1, an auxiliary pole magnet 65, a direction of magnetization of which is the circumferential direction C2, and an auxiliary pole magnet 66, a direction of magnetization of which is the circumferential direction C1.

In the rotor 3 shown in FIG. 15, the array of the plurality of permanent magnets 6 is the Halbach magnet array on both of a surface opposed to the stator 4 ana a surface opposed to the stator 5. Specifically, on the surface opposed to the stator 4, the permanent magnets 6 are magnetized such that the direction of magnetization rotates counterclockwise in the circumferential direction C1. On the surface opposed to the stator 5, the permanent magnets 6 are magnetized such that the direction of magnetization rotates clockwise in the circumferential direction C1.

With such a Halbach magnet array, compared with the normal magnet array, it is possible to increase the intensities of magnetic fields respectively formed in a space on the stator 4 side and a space on the stator 5 side from the rotor 3. As a result, it is possible to efficiently put magnetic fluxes into the slots. It is possible to achieve an increase in the torque of the axial gap motor 1F.

In the axial gap motor 1F shown in FIG. 15, the length L1 of the stator core 42 in the circumferential direction C is equal to length L2 of the main magnetic pole magnet 63 and length L3 of the main magnetic pole magnet 64 in the circumferential direction C. In addition, the length of one unit of slots indicated by a thick line in FIG. 15 is equal to the length of one unit of the permanent magnets 6 indicated by a thick line in FIG. 15. Consequently, it is possible to efficiently offset cogging torques between the rotor 3 and the stators 4 and 5.

In the third embodiment explained above, the same effects as the effects in the second embodiment are obtained.

### 5. Fourth Embodiment

A rotary motor according to a fourth embodiment is explained.

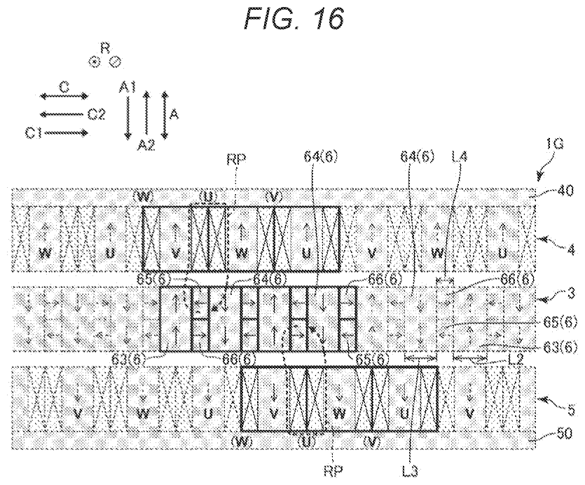

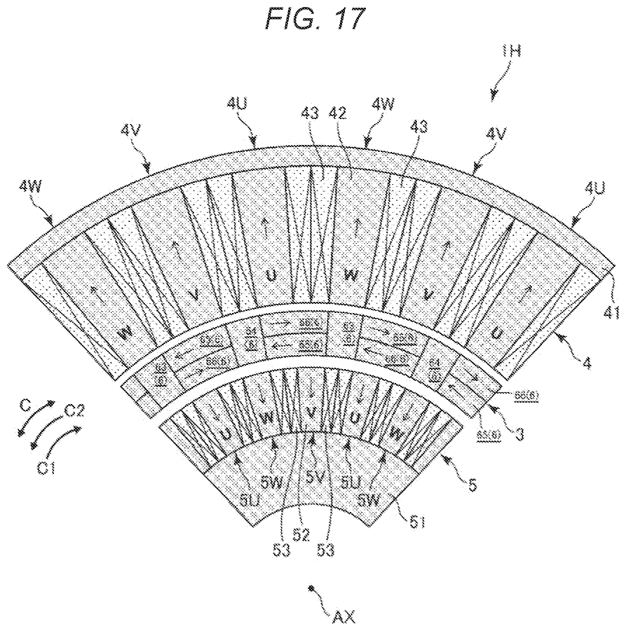

FIG. 16 is a sectional view of an axial gap motor 1G, which is the rotary motor according to the fourth embodiment, taken along a surface orthogonal to the radial direction R.

The fourth embodiment is explained below. In the following explanation, differences from the third embodiment are mainly explained. Explanation about similarities to the third embodiment is omitted. In FIG. 16, the same components as the components in the third embodiment are denoted by the same reference numerals and signs.

This embodiment is the same as a third embodiment except that the length of one unit in the circumferential direction C of the permanent magnets 6 arrayed in the Halbach magnet array is a half of the length in the third embodiment. Therefore, in FIG. 16, the permanent magnets 6 for two units are indicated by a thick line. The stator 4 according to this embodiment includes a back yoke 40. The stator 5 according to this embodiment includes a back yoke 50.

By reducing the length of one unit of the Halbach magnet array, the number of poles of the permanent magnets 6 can be increased. Specifically, as shown in FIG. 15, the axial gap motor 1F according to the third embodiment explained above has a two-pole three-slot configuration. Therefore, in the axial gap motor 1F according to the third embodiment, signals are supplied to the stators 4 and 5 in the order of the U phase, the V phase, and the W phase with respect to a rotating direction of the rotor 3.

In contrast, as shown in FIG. 16, the axial gap motor 1G according to this embodiment has a four-pole three-slot configuration. Therefore, in the axial gap motor 1G, signals are supplied to the stators 4 and 5 in the order of the U phase, the W phase, and the V phase with respect to the rotating direction of the rotor 3. Consequently, it can be considered that signals skipping every other parenthesized phases in the back yokes 40 and 50 shown in FIG. 16 are supplied. As a result, compared with the third embodiment, it is possible to secure spaces for placing lead wires of the coils compared with the third embodiment without changing the structure of the slots. It is possible to achieve multipolarization while maintaining the number of windings of the lead wires. Consequently, it is possible to achieve a reduction in torque fluctuation while maintaining the increase in torque.

Since the least common multiple of the number of poles and the number of slots is increased by changing a ratio of the number of poles and the number of slots in this way, it is possible to reduce torque fluctuation involved in cogging torque compared with the third embodiment.

Further, in this embodiment, compared with the third embodiment, the length L2 of the main magnetic pole magnet 63 and the length L3 of the main magnetic pole magnet 64 in the circumferential direction C are not changed and length L4 of the auxiliary pole magnets 65 and 66 in the circumferential direction C is reduced to a quarter. Consequently, in FIG. 16, as explained above, two units of the permanent magnets 6 are allocated with respect to one unit of the slots of the stators 4 and 5. As a result, magnetic fluxes formed by the permanent magnets 6 according to the rotation of the rotor 3 form magnetic flux loops RP that pass through the back yokes 40 and 50 as shown in FIG. 16. Since the number of poles is increased, the magnetic flux loops RP have a short route path compared with the third embodiment. Therefore, in the axial gap motor 1G, it is possible to achieve both of a reduction in size and an increase in torque.

In the case of the Halbach magnet array, when the length L2 of the main magnetic pole magnet 63 and the length L3 of the main magnetic pole magnet 64 do not change even if the length L4 of the auxiliary pole magnets 65 and 66 is reduced, the intensity of a magnetic field formed from the rotor 3 less easily decreases. Therefore, by adopting the Halbach magnet array, it is easy to achieve both of a reduction in size and an increase in torque.

### 6. Fifth Embodiment

A rotary motor according to a fifth embodiment is explained.

FIG. 17 is a sectional view of a part of a radial gap motor 1H, which is the rotary motor according to the fifth embodiment, taken along a surface orthogonal to the rotation axis AX.

The fifth embodiment is explained below. In the following explanation, differences from the third embodiment are mainly explained. Explanation about similarities to the third embodiment is omitted. In FIG. 17, the same components as the components in the third embodiment are denoted by the same reference numerals and signs.

Whereas the rotary motor according to the third embodiment explained above is the axial gap motor 1F, the rotary motor according to this embodiment is the radial gap motor 1H.

The radial gap motor 1H includes the stator 4 (the first stator) located on the outer circumference side, the stator 5 (the second stator) located on the inner circumference side, and the rotor 3 disposed between the stator 4 and the stator 5 via a gap.

The stator 4 includes the plurality of stator cores (the first cores) and the coil 43 (the first coil) wound around each of the stator cores 42. A signal of any one of the U phase (the first phase), the V phase (the second phase), and the W phase (the third phase) forming the three-phase alternating current flows to the coil 43.

The stator 5 includes the plurality of stator cores (the second cores) and the coil 53 (the second coil) wound around each of the stator cores 52. A signal of any one of the U phase, the V phase, and the W phase forming the three-phase alternating current flows to the coil 53.

The rotor 3 includes the plurality of permanent magnets 6 arranged side by side in the circumferential direction C around the rotation axis AX. In the rotor 3 shown in FIG. 17 as well, the plurality of permanent magnets 6 are arrayed in the Halbach magnet array on both of the surface opposed to the stator 4 and the surface opposed to the stator 5.

In the radial gap motor 1H, the U-phase slot 4U and the U-phase slot 5U are shifted from each other in the circumferential direction C. More specifically, the center of gravity of the stator core 42, around which the coil 43 to which the signal of the U phase flows is wound, and the center of gravity of the stator core 52, around which the coil 53 to which the signal of the U phase flows is wound, are shifted from each other in the circumferential direction C.

The V-phase slot 4V and the V-phase slot 5V are also shifted from each other in the circumferential direction C. More specifically, the center of gravity of the stator core 42 included in the V-phase slot 4V and the center of gravity of the stator core 52 included in the V-phase slot 5V are shifted from each other in the circumferential direction C.

Further, the W-phase slot 4W and the W-phase slot 5W are also shifted from each other in the circumferential direction C. More specifically, the center of gravity of the stator core 42 included in the W-phase slot 4W and the center of gravity of the stator core 52 included in the W-phase slot 5W are shifted from each other in the circumferential direction C.

In the fifth embodiment explained above, the same effects as the effects in the third embodiment are obtained.

### 7. Sixth Embodiment

A robot according to a sixth embodiment is explained.

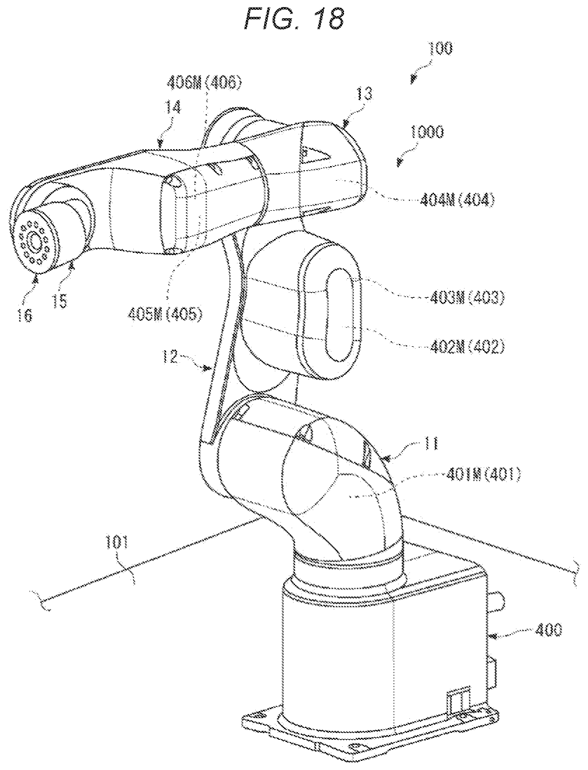

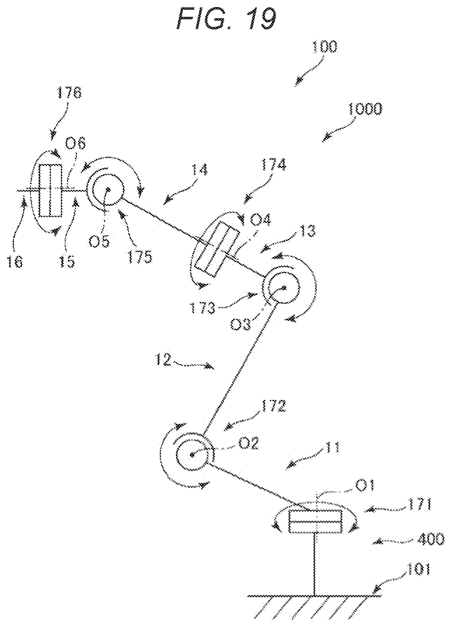

FIG. 18 is a perspective view showing the robot according to the sixth embodiment. FIG. 19 is a schematic diagram of the robot shown in FIG. 18.

A robot 100 shown in FIG. 18 is used in kinds of work such as conveyance, assembly, and inspection of various workpieces (target objects).

As shown in FIGS. 18 and 19, the robot 100 includes a base 400, a robot arm 1000, and driving sections 401 to 406.

The base 400 shown in FIGS. 18 and 19 is placed on a flat floor 101. The base 400 may be placed not on the floor 101 but on a wall, a ceiling, a stand, or the like.

The robot arm 1000 shown in FIGS. 18 and 19 includes a first arm 11, a second arm 12, a third arm 13, a fourth arm 14, a fifth arm 15, and a sixth arm 16. A not-shown end effector can be detachably attached to the distal end of the sixth arm 16. A workpiece can be, for example, gripped by the end effector. The workpiece, for example, gripped by the end effector is not particularly limited. Examples of the end effector include an electronic component and an electronic device. In this specification, the base 400 side based on the sixth arm 16 is represented as “proximal end side” and the sixth arm 16 side based on the base 400 is represented as “distal end side”.

The end effector is not particularly limited. Examples of the end effector include a hand that grips the workpiece and a suction head that sucks the workpiece.

The robot 100 is a single-arm six-axis vertical articulated robot in which the base 400, the first arm 11, the second arm 12, the third arm 13, the fourth arm 14, the fifth arm 15, and the sixth arm 16 are coupled in this order from the proximal end side toward the distal end side. In the following explanation, the first arm 11, the second arm 12, the third arm 13, the fourth arm 14, the fifth arm 15, and the sixth arm 16 are respectively referred to as “arms” as well. The lengths of the arms 11 to 16 are respectively not particularly limited and can be set as appropriate. The number of arms included in the robot arm 1000 may be one to five or seven or more. The robot 100 may be a SCARA robot or may be a double-arm robot including two or more robot arms 1000.

The base 400 and the first arm 11 are coupled via a joint 171. The first arm 11 is capable of turning with respect to the base 400 with a first turning axis O1 parallel to the vertical axis as a turning center. The first arm 11 is turned by driving of the driving section 401 including a motor 401M and a not-shown speed reducer. The motor 401M generates a driving force for turning the first arm 11.

The first arm 11 and the second arm 12 are coupled via a joint 172. The second arm 12 is capable of turning with respect to the first arm 11 with a second turning axis O2 parallel to the horizontal plane as a turning center. The second arm 12 is turned by driving of the driving section 402 including a motor 402M and a not-shown speed reducer. The motor 402M generates a driving force for turning the second arm 12.

The second arm 12 and the third arm 13 are coupled via a joint 173. The third arm 13 is capable of turning with respect to the second arm 12 with a third turning axis O3 parallel to the horizontal plane as a turning center. The third arm 13 is turned by driving of the driving section 403 including a motor 403M and a not-shown speed reducer. The motor 403M generates a driving force for turning the third arm 13.

The third arm 13 and the fourth arm 14 are coupled via a joint 174. The fourth arm 14 is capable of turning with respect to the third arm 13 with a fourth turning axis O4 parallel to the center axis of the third arm 13 as a turning center. The fourth arm 14 is turned by driving of the driving section 404 including a motor 404M and a not-shown speed reducer. The motor 404M generates a driving force for turning the fourth arm 14.

The fourth arm 14 and the fifth arm 15 are coupled via a joint 175. The fifth arm 15 is capable of turning with respect to the fourth arm 14 with a fifth turning axis O5 orthogonal to the center axis of the fourth arm 14 as a turning center. The fifth arm 15 is turned by driving of the driving section 405 including a motor 405M and a not-shown speed reducer. The motor 405M generates a driving force for turning the fifth arm 15.

The fifth arm 15 and the sixth arm 16 are coupled via a joint 176. The sixth arm 16 is capable of turning with respect to the fifth arm 15 with a sixth turning axis O6 parallel to the center axis of the distal end portion of the fifth arm 15 as a turning center. The sixth arm 16 is turned by driving of the driving section 406 including a motor 406M and a not-shown speed reducer. The motor 406M generates a driving force for turning the sixth arm 16.

The rotary motor according to any one of the embodiments explained above is used as at least one of the motors 401M to 406M. That is, the robot 100 includes the rotary motor according to any one of the embodiments explained above.

The rotary motor according to any one of the embodiments is excellent in controllability because large torque fluctuation involved in cogging torque is suppressed. Therefore, the robot 100 is excellent in controllability of the robot arm 1000 and is excellent in convenience of use. When the rotary motor is the axial gap motor, it is possible to easily achieve a reduction in the size and improvement of design flexibility of the robot arm 1000.

Not-shown angle sensors are provided in the driving sections 401 to 406. Examples of the angle sensors include various encoders such as a rotary encoder. The angle sensors detect turning angles of output shafts of the motors or the speed reducers of the driving sections 401 to 406.

The driving sections 401 to 406 and the angle sensors are respectively electrically coupled to not-shown robot control devices. The robot control devices independently control the operations of the driving sections 401 to 406.

The rotary motor and the robot according to the present disclosure are explained above with reference to the embodiments shown in the figures. However, the present disclosure is not limited to the embodiments.

For example, the rotary motor and the robot according to the present disclosure may be respectively a rotary motor and a robot in which the sections in the embodiments are replaced with any components having the same functions or may be a rotary motor and a robot in which any components are added to the embodiments.

What is claimed is:

1. A rotary motor comprising:
a first stator including a plurality of first cores and a first coil wound around each of the first cores, a signal of any one of a first phase, a second phase, and a third phase forming a three-phase alternating current flowing to the first coil;
a second stator including a plurality of second cores and a second coil wound around each of the second cores, a signal of any one of the first phase, the second phase, and the third phase forming the three-phase alternating current flowing to the second coil; and
a rotor disposed between the first stator and the second stator via a gap and including a plurality of magnets arranged side by side in a circumferential direction around a rotation axis, wherein
a center of gravity of the first core around which the first coil to which the signal flows is wound and a center of gravity of the second core around which the second coil to which a signal of a same phase as the phase of the signal flowing to the first coil flows is wound are shifted from each other in the circumferential direction.

2. The rotary motor according to claim 1, wherein
a shift amount of the center of gravity of the first core and the center of gravity of the second core in the circumferential direction is equal to a half of a cycle of the magnets in the circumferential direction, and
length of the first core in the circumferential direction is equal to or larger than an interval between the second cores adjacent to each other in the circumferential direction.

3. The rotary motor according to claim 2, wherein the length of the first core in the circumferential direction is equal to the interval between the second cores adjacent to each other in the circumferential direction.

4. The rotary motor according to claim 2, wherein a direction of the signal flowing in the first coil and a direction of the signal flowing in the second coil are opposite to each other.

5. The rotary motor according to claim 2, wherein, when viewed from a position along the rotation axis, the center of gravity of the first core is located in a middle of centers of gravity of the second cores adjacent to each other in the circumferential direction.

6. The rotary motor according to claim 1, wherein an array of the plurality of magnets is a Halbach magnet array.

7. The rotary motor according to claim 1, wherein the rotary motor is an axial gap motor.

8. A robot comprising the rotary motor according to claim 1.
